(19) United States
(12) Patent Application Publication
(10) Pub. No.: US 2026/0121133 A1
(43) Pub. Date: Apr. 30, 2026

(54) BATTERY PACK

(71) Applicant: Samsung SDI Co., Ltd., Yongin-si (KR)

(72) Inventor: Minsu Kim, Yongin-si (KR)

(21) Appl. No.: 19/008,480

(22) Filed: Jan. 2, 2025

(30) Foreign Application Priority Data
May 30, 2024 (KR) 10-2024-0071003

(51) Int. Cl. H01M 10/42; B06B 1/06; H01M 10/48; H01M 50/209

(52) U.S. Cl. CPC H01M 10/425; B06B 1/06; H01M 10/48; H01M 50/209; H01M 2010/4271

(57) ABSTRACT

A battery pack includes: a battery cell including a case forming an external shape, an electrode assembly, and an electrolyte, the electrode assembly and the electrolyte being accommodated together inside the case; and a vibrator on the case of the battery cell and configured to generate a vibration wave propagating inside the case to suppress or decompose precipitation of dendrites or lithium salts from the electrolyte.

### CROSS-REFERENCE TO RELATED APPLICATION

The present application claims priority to and the benefit of Korean Patent Application No. 10-2024-0071003, filed on May 30, 2024, in the Korean Intellectual Property Office, the entire disclosure of which is incorporated herein by reference.

### BACKGROUND

### 1. Field

Aspects of one or more embodiments relate to a battery pack.

### 2. Description of the Related Art

In general, secondary batteries are batteries that can be repeatedly charged and discharged, unlike primary batteries that cannot be charged. Secondary batteries may be used as energy sources for mobile devices, electric vehicles, hybrid vehicles, electric bicycles, uninterruptible power supply, etc. Secondary batteries may be used in the form of a single battery or in the form of a module bundled as a unit by connecting a plurality of batteries, depending on the type of external device to be applied.

Small mobile devices, such as mobile phones, may operate for a certain period of time with the output and capacity of a single battery. However, larger mobile devices, such as laptops, or electric vehicles and hybrid vehicles that consume a lot of power require long-term operation and high power operation. In this case, a battery pack containing multiple batteries may be desirable due to issues of output and capacity, and the output voltage or output current may be relatively increased depending on the number of batteries built in the battery pack.

The above information disclosed in this Background section is only for enhancement of understanding of the background and therefore the information discussed in this Background section does not necessarily constitute prior art.

### SUMMARY

Aspects of one or more embodiments include a battery pack, which can suppress the formation or growth of dendrites or lithium salts that may precipitate on the electrolyte charged inside a battery cell as the battery cell is repeatedly charged and discharged, can prevent shortening of the lifespan of the battery cell by decomposing previously formed dendrites or lithium salts, thereby promoting electrochemical reactions for charging and discharging the battery cell, and can prevent accidents such as fire or explosion due to internal short circuit.

Additional aspects will be set forth in part in the description which follows and, in part, will be apparent from the description, or may be learned by practice of the presented embodiments of the present disclosure.

According to some embodiments of the present disclosure, a battery pack includes: a battery cell including a case forming an external shape, an electrode assembly, and an electrolyte, the electrode assembly and the electrolyte being accommodated together inside the case, and a vibrator on the case of the battery cell and configured to generate a vibration wave propagating inside the case to suppress or decompose precipitation of dendrites or lithium salts from the electrolyte.

According to some embodiments, the vibrator may be further configured to generate a vibration wave that propagates from the outside of the case through the case to the electrolyte inside the case.

According to some embodiments, the case may include a pair of main surfaces facing each other in a first direction, the pair of main surfaces occupying the largest area of the case, a pair of side surfaces facing each other in a second direction crossing the first direction, and an electrode surface, on which an electrode terminal is formed, and a bottom surface opposite to the electrode surface, the electrode surface and the bottom surface facing each other in a third direction crossing the first and second directions.

According to some embodiments, the battery cell may include a plurality of battery cells arranged in the first direction so that the main surfaces face each other.

According to some embodiments, the vibrator may be on a side surface of the battery cell.

According to some embodiments, a side surface of the battery cell, on which the vibrator is located, may have a narrower area than a main surface of the battery cell, an electrode surface of the battery cell, and a bottom surface of the battery cell.

According to some embodiments, the battery cell may be configured to have a thickness of the battery cell in the first direction in which the pair of main surfaces face each other, have a width of the battery cell in the second direction in which the pair of side surfaces face each other, and have a height of the battery cell in the third direction in which the electrode surface and the bottom surface face each other, wherein the width of the battery cell may be greater than the height of the battery cell, and the height of the battery cell may be greater than the thickness of the battery cell.

According to some embodiments, the vibrator may be further configured to generate a vibration wave propagating along a width of the battery cell, which is the longest among a thickness of the battery cell, a width of the battery cell, and a height of the battery cell, from the side surface of the battery cell, which has the smallest area from among the main surface, side surface, electrode surface, and bottom surface of the battery cell.

According to some embodiments, the vibrator may include a pair of vibrators facing each other on the pair of side surfaces facing each other in the second direction.

According to some embodiments, the battery pack may further include a driving circuit electrically connected to the vibrator, wherein the driving circuit may be configured to generate an electrical driving signal to output a vibration wave propagating inside the battery cell.

According to some embodiments, an operation of the driving circuit may be controlled from a battery management system (BMS) for controlling charging and discharging operations of the battery cell.

According to some embodiments, the BMS may be configured to, based on state information obtained from the battery cell, select between a driving mode, in which a driving signal of the vibrator is applied as a continuous waveform, and a driving mode, in which the driving signal of the vibrator is applied as a discontinuous pulse waveform, and control driving of the vibrator in a selected driving mode.

According to some embodiments, the BMS may be further configured to, according to sizes or growth rates of dendrite or lithium salt precipitates measured or predicted from the state information of the battery cell, select between a driving mode based on a continuous waveform having a natural frequency or resonant frequency of lithium crystals forming the dendrites or lithium salts and a driving mode based on a discontinuous waveform including pulse waveforms spaced apart from each other with a pause period between the pulse waveforms along a time axis and control driving of the vibrator in a selected driving mode.

According to some embodiments, the BMS may be configured to control charging and discharging operations of the battery cell based on state information obtained from the battery cell and control driving of the vibrator.

According to some embodiments, the case may include a pair of main surfaces facing each other in a first direction, the pair of main surfaces occupying the largest area of the case, and a pair of side surfaces facing each other in a second direction crossing the first direction, wherein the vibrator may include a pair of vibrators facing each other on the pair of side surfaces facing each other in the second direction, wherein driving signals of alternating pulse waveforms may be applied to the pair of vibrators located on the pair of side surfaces facing each other.

According to some embodiments, a driving signal applied to the vibrator may have a continuous waveform.

According to some embodiments, the driving signal may have a continuous waveform having a natural frequency or resonance frequency of lithium crystals forming dendrites or lithium salts.

According to some embodiments, a driving signal applied to the vibrator may have a discontinuous pulse waveform.

According to some embodiments, the driving signal may have a pulse waveform including a plurality of pulses spaced apart from each other with a pause period between the plurality of pulses along a time axis.

According to some embodiments, the vibrator may generate ultrasonic vibration in an ultrasonic wavelength range.

According to some embodiments, the vibrator may include a piezoelectric vibrator for converting electrical vibration into mechanical vibration through a piezoelectric effect.

### BRIEF DESCRIPTION OF THE DRAWINGS

The above and other aspects, features, and characteristics of certain embodiments of the present disclosure will be more apparent from the following description taken in conjunction with the accompanying drawings, in which:

FIG. 1 is an exploded perspective view of a battery pack according to some embodiments of the present disclosure;

FIG. 2 is a perspective view of a battery cell shown in FIG. 1;

FIGS. 3A to 3C each show the internal structure of the battery cell shown in FIG. 2 and are cross-sectional views taken along the line III-III in FIG. 2, and FIGS. 3B and 3C are schematic views showing alternating vibration driving by a pair of vibrators located on both sides of the battery cell and the resulting propagation of vibration waves;

FIG. 4 is an expanded view of an electrode assembly shown in FIGS. 3A to 3C;

FIG. 5 is a view showing the propagation of a vibration wave according to some embodiments of the present disclosure, and shows the propagation form of a longitudinal wave;

FIG. 6 is a view showing an example of a driving mode in which a driving signal having a continuous waveform is applied to a vibrator V shown in FIG. 1;

FIG. 7 is a view showing the amplification ratio of an output signal to an input signal with respect to the frequency of a vibration wave generated from the vibrator V;

FIG. 8 is a view showing an example of a driving mode in which a driving signal having a discontinuous pulse waveform is applied to the vibrator V shown in FIG. 1; and

FIG. 9 is a view for explaining the operation of a battery management system (BMS) that controls the charging and discharging of a battery cell C shown in FIG. 1 and the driving of the vibrator V.

### DETAILED DESCRIPTION

Reference will now be made in more detail to aspects of some embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Throughout the present disclosure, the expression “at least one of a, b or c” indicates only a, only b, only c, both a and b, both a and c, both b and c, all of a, b, and c, or variations thereof.

Hereinafter, a battery pack according to some embodiments of the present disclosure will be described in more detail with reference to the attached drawings.

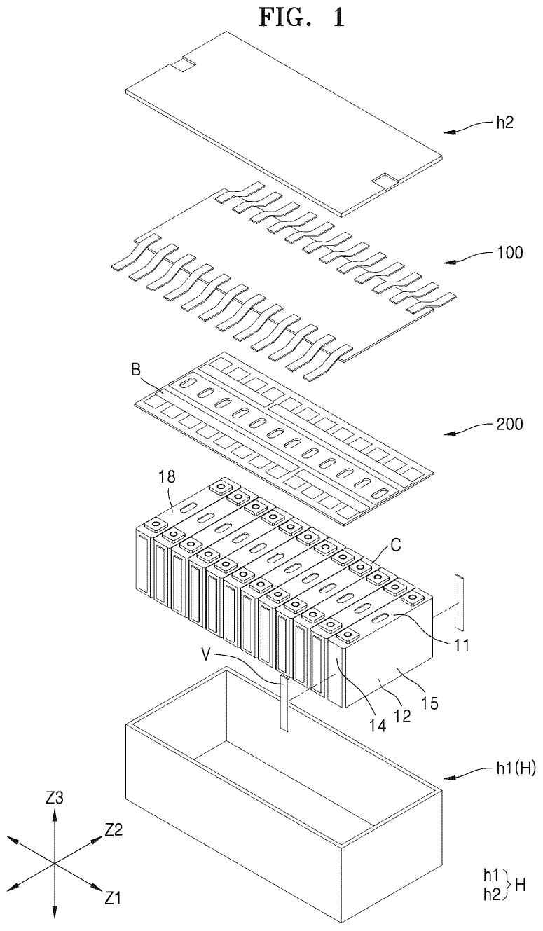

FIG. 1 is an exploded perspective view of a battery pack according to some embodiments of the present disclosure.

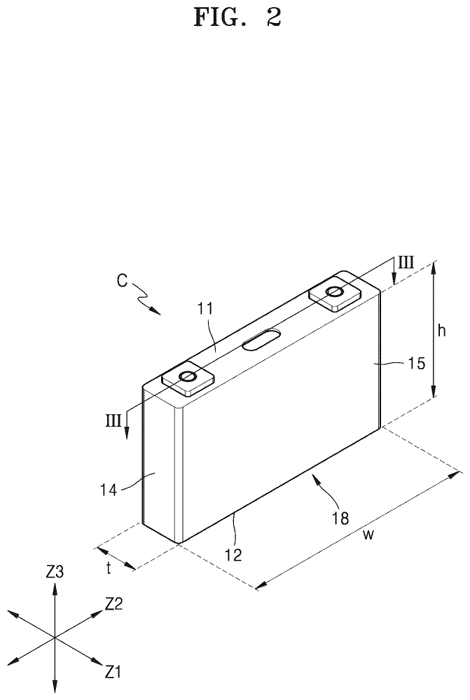

FIG. 2 is a perspective view of a battery cell shown in FIG. 1.

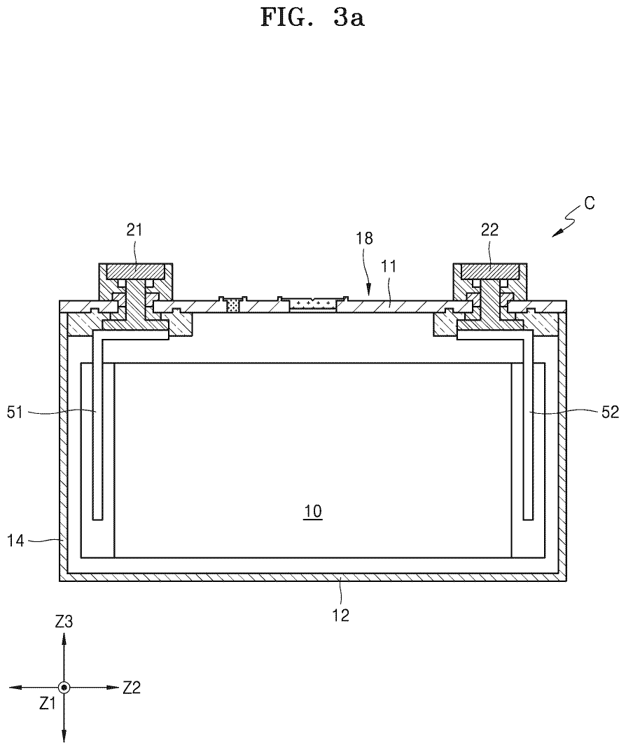

FIGS. 3A to 3C each show the internal structure of the battery cell shown in FIG. 2 and are cross-sectional views taken along the line III-III in FIG. 2. FIGS. 3B and 3C are schematic views showing alternating vibration driving by a pair of vibrators located on both sides of the battery cell and the resulting propagation of vibration waves.

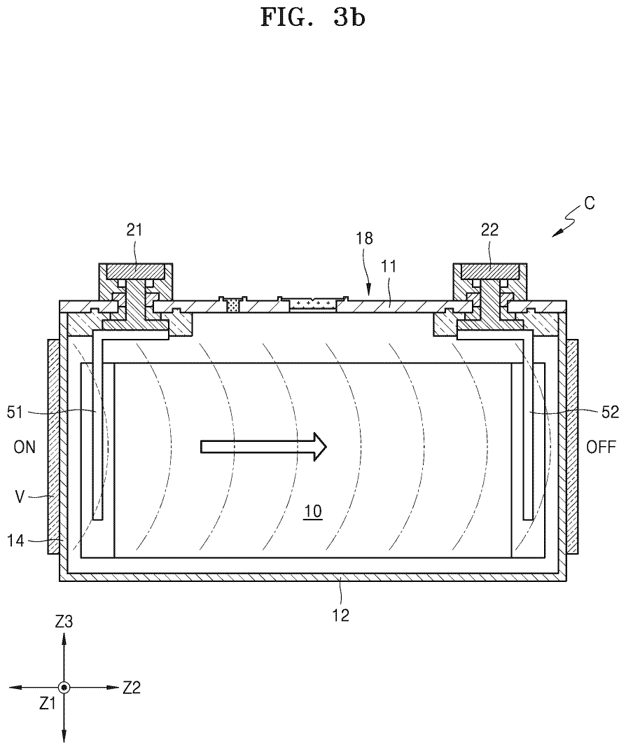

FIG. 4 is an expanded view of an electrode assembly shown in FIGS. 3A to 3C.

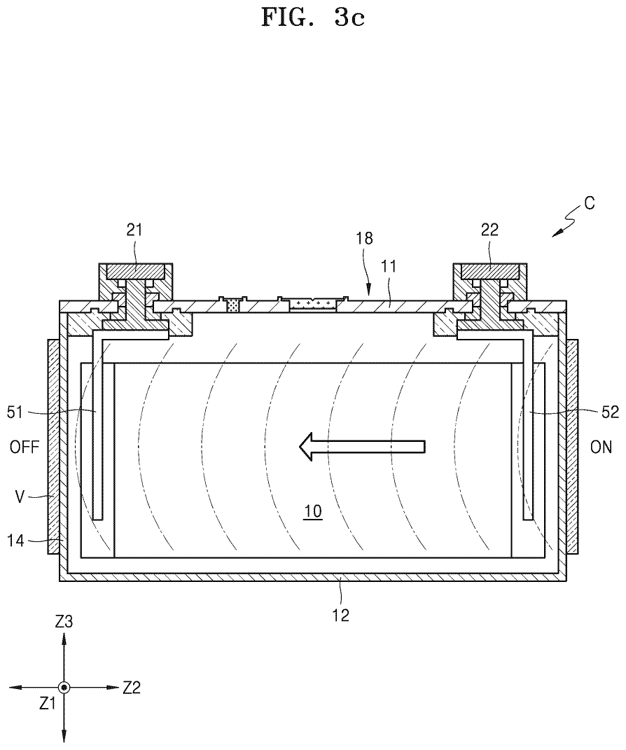

FIG. 5 is a view showing the propagation of a vibration wave according to some embodiments of the present disclosure, and shows the propagation form of a longitudinal wave.

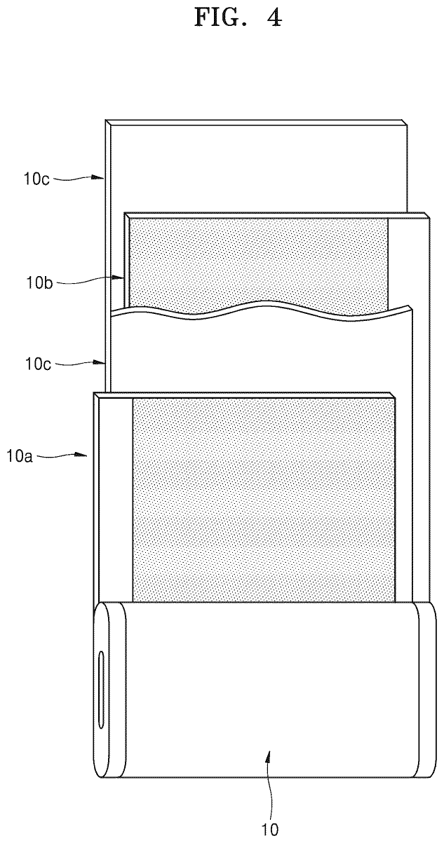

FIG. 6 is a view showing an example of a driving mode in which a driving signal having a continuous waveform is applied to a vibrator V shown in FIG. 1.

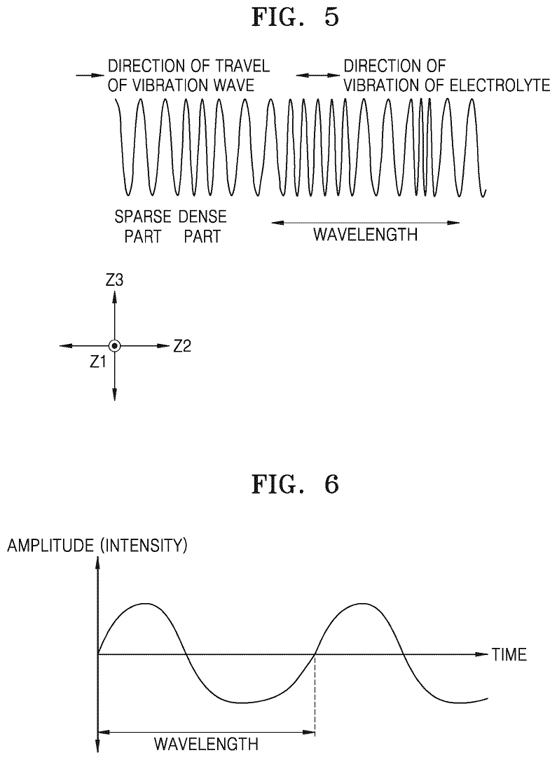

FIG. 7 is a view showing the amplification ratio of an output signal to an input signal with respect to the frequency of a vibration wave generated from the vibrator V.

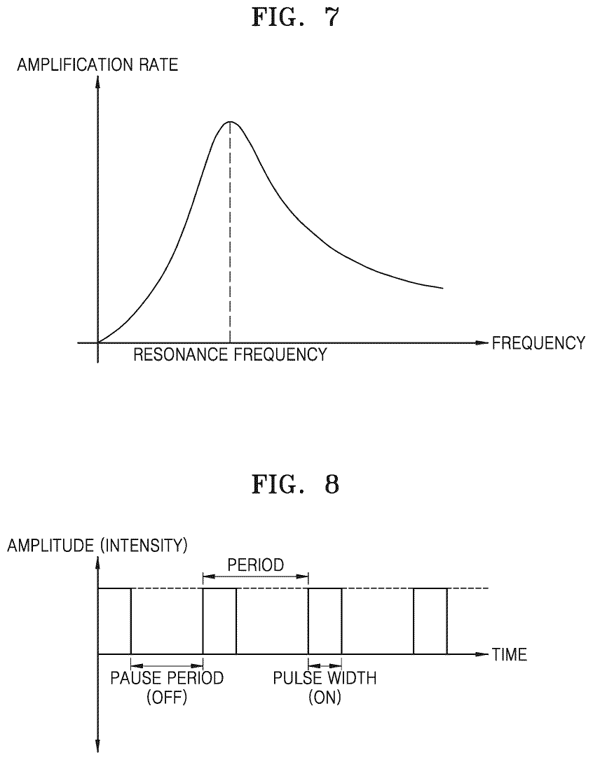

FIG. 8 is a view showing an example of a driving mode in which a driving signal having a discontinuous pulse waveform is applied to the vibrator V shown in FIG. 1.

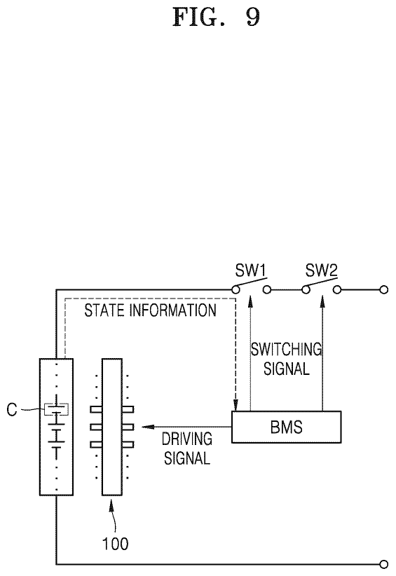

FIG. 9 is a view for explaining the operation of a battery management system (BMS) that controls the charging and discharging of a battery cell C shown in FIG. 1 and the driving of the vibrator V.

Referring to the drawings, a battery pack according to some embodiments of the present disclosure may include a plurality of battery cells C arranged in a first direction Z1, a vibrator V located on one side of at least one battery cell C among the plurality of battery cells C, a flexible printed circuit board 100 extending in the first direction Z1, in which the battery cells C are arranged to apply a driving signal to the vibrator V, and electrically connected to the vibrator V located in each of the battery cells C, and a housing H that accommodates the plurality of battery cells C. According to some embodiments of the present disclosure, the housing H may include a lower housing h1 and an upper housing h2 assembled to face each other in a third direction Z3 to accommodate a wiring circuit 200, which includes a bus bar B for electrically connecting different battery cells C, and a flexible printed circuit board 100 as a driving circuit for applying a driving signal to the vibrator V located on one side of the battery cell C.

According to some embodiments of the present disclosure, the battery cell C may include a pair of main surfaces 15, on which neighboring battery cells C face each other in the first direction Z1 in which the plurality of battery cells C are arranged, a pair of side surfaces 14, which connect the pair of main surfaces 15 and face each other in a second direction Z2 crossing the first direction Z1, and an electrode surface 11 and a bottom surface 12, which face each other in a third direction Z3 crossing the first and second directions Z1 and Z2.

According to some embodiments of the present disclosure, the vibrator V may be located on the pair of side surfaces 14 arranged to face each other in the second direction Z2 crossing the first direction Z1 in which the plurality of battery cells C are arranged. For example, according to some embodiments of the present disclosure, the vibrator V may not be located on the pair of main surfaces 15 facing each other in the first direction Z1 in which the plurality of battery cells C are arranged.

According to some embodiments of the present disclosure, the main surfaces 15, which face each other in the first direction Z1 in which the plurality of battery cells C are arranged, may occupy the widest area in a hexahedral shape formed by the battery cell C or the case 18 of the battery cell C. In this regard, volume expansion or swelling due to charging and discharging of the battery cell C may be most noticeable on the pair of main surfaces 15 among the pair of main surfaces 15 facing each other in the first direction Z1, the pair of side surfaces 14 facing each other in the second direction Z2, and the electrode surface 11 and bottom surface 12 facing each other in the third direction Z3. In this way, if the vibrator V is placed on the main surface 15 that may experience the most swelling, an extra space, which may be accepted or absorbed by the vibrator V located between the main surfaces 15 of battery cells C adjacent to each other in the first direction Z1, may be provided, and the output characteristics of the battery cell C may deteriorate as the resistance characteristics change due to excessive swelling of the battery cell C. According to some embodiments of the present disclosure, physical interference with the swelling of the battery cell C may be forced according to the vibration wave (e.g., ultrasonic vibration) provided from the vibrator V, and safety accidents, such as explosion or ignition of the battery cell C, may occur as excessive pressure builds up inside the battery cell C due to excessive suppression of swelling of the battery cell C.

According to some embodiments of the present disclosure, the vibrator V may be located on the pair of side surfaces 14 facing each other in the second direction Z2 crossing the first direction Z1, rather than the pair of main surfaces 15 facing each other in the first direction Z1 in which the plurality of battery cells C are arranged, and may not be located on the electrode surface 11 and the bottom surface 12, which face each other in the third direction Z3 crossing the first and second directions Z1 and Z2. For example, electrode terminals 21 and 22 through which charge and discharge currents of the battery cell C flow may be formed on the electrode surface 11 of the battery cell C, and in order not to interfere with the electrical connection of the electrode terminals 21 and 22, the vibrator V may not be located on the electrode surface 11 of the battery cell C on which the electrode terminals 21 and 22 are formed.

According to some embodiments of the present disclosure, the battery cell C may have a thickness t in the first direction Z1 in which the pair of main surfaces 15 face each other, may have a width w in the second direction Z2 in which the pair of side surfaces 14 face each other, and may have a height h in the third direction Z3 in which the electrode surface 11 and the bottom surface 12 face each other. In this way, the battery cell C may be defined as a dimension of width w×thickness t×height h. According to some embodiments of the present disclosure, the battery cell C may be configured such that the width w of the battery cell C is greater than the height h of the battery cell C and the height h of the battery cell C is greater than the thickness t of the battery cell C.

According to some embodiments of the present disclosure, the side surface 14 on which the vibrator V is located may be formed to have a small area than the main surface 15, the electrode surface 11, and the bottom surface 12, which form surfaces other than the side surface 14. For example, the vibrator V located on the side surface 14 may form a wave source of a vibration wave (e.g., ultrasonic vibration) propagating from the side surface 14, which occupies the smallest area in the hexahedral shape that forms the outer shape of the battery cell C, in the second direction Z2 corresponding to the width w of the battery cell C.

As such, according to some embodiments of the present disclosure, the vibrator V may be located on the side surface 14 of the battery cell C occupying a small area and a vibration wave generated from the vibrator V may propagate along the width w of the battery cell C forming the longest dimension with the minimum wave front with respect to an electrolyte E accommodated inside the case 18. For example, the appearance specification of the battery cell C may be set such that the width w of the battery cell C is the longest dimension among the dimensions of width w×thickness t×height h.

According to some embodiments of the present disclosure, the side surface 14 of the battery cell C on which the vibrator V is located may transmit a vibration wave (e.g., ultrasonic vibration) of the vibrator V toward the electrolyte E contained within the case 18 and may form a wave front according to the shape of the case 18 (i.e., the shape of the side surface 14 of the case 18 forming a wave source of the vibration wave) or a deformed shape of the case 18 (i.e., a deformed shape of the side surface 14 of the case 18 forming a wave source of the vibration wave).

For example, at both ends of the side surface 14 on which the vibrator V is placed, deformation may be limited due to physical interference with the main surface 15, the electrode surface 11, and the bottom surface 12, which are in contact with the side surface 14, and thus, the wave front of the vibration wave (e.g., ultrasonic vibration) propagating into the electrolyte E may be formed as a round wave front forming a curved portion from both end positions to a central position in the direction (the third direction Z3) of the height h in which the side surface 14 of the battery cell C extends.

According to some embodiments of the present disclosure, by placing the vibrator V on the side surface 14, which occupies the smallest area in the hexahedral shape of the battery cell C, the area of the wave front formed by the side surface 14 of the battery cell C may be limited. As the vibration wave travels along the width w, which forms the maximum dimension among the dimensions of width w×thickness t×height h formed by the hexahedral shape of the battery cell C, the flow of the battery cell C due to the transmission of the vibration wave may be suppressed, and the internal structure of the battery cell C may be protected.

According to some embodiments of the present disclosure, the case 18 providing the side surface 14 of the battery cell C, on which the vibrator V is located, or the external appearance of the battery cell C may transmit the vibration wave of the vibrator V toward the electrolyte E contained within the case 18. The material properties of a metal material forming the case 18, for example, characteristic parameters of the metal material that mainly affect the deformation behavior of the case 18 or the vibration behavior of the case 18, such as the rigidity and elasticity of aluminum or aluminum alloy that forms the case 18, may be set in conjunction with the output of the vibrator V located on the case 18 (i.e., the side surface 14 of case 18). For example, rather than the vibration output of the vibrator V being directly transmitted to the electrolyte E inside the case 18, the vibration output of the vibrator V, which reflects the material properties of the metal material forming the case 18 of the battery cell C, may be transmitted to the electrolyte E inside the case 18.

According to some embodiments of the present disclosure, the fact that the vibrator V is located on the pair of side surfaces 14 facing each other in the second direction Z2 may mean that the vibrator V is located on both of the pair of side surfaces 14 facing each other in the second direction Z2 or located on any one of the pair of side surfaces 14 facing each other in the second direction Z2. According to some embodiments of the present disclosure, an electrical pulse signal for applying a vibration wave (e.g., ultrasonic vibration) to the side surface 14 of the battery cell C may be input to the vibrator V located on the side surfaces 14 of the battery cell C facing each other in the second direction Z2, and the vibrator V may output physical vibration by receiving the electrical pulse signal as an input.

According to some embodiments of the present disclosure, different types of pulse signals in which pulses appear alternating with each other may be input to the vibrator V located on the pair of side surfaces 14 of the battery cell C facing each other. For example, according to some embodiments of the present disclosure, a pulse signal in which pulses periodically appear may be input to a pair of vibrators V located on the pair of side surfaces 14 of the battery cell C facing each other. In this case, different types of pulse signals, in which pulses inducing deformation of the side surfaces 14 of the battery cell C appear alternating with each other over time, may be input to the pair of vibrators V, respectively.

According to some embodiments of the present disclosure, the vibrator V may induce deformation of the side surfaces 14 of the battery cell C by inputting different types of pulse signals in which pulses periodically appear, and may generate vibration waves that form a wave front from the side surfaces 14 of the battery cell C while inducing deformation of the side surfaces 14 of the battery cell C at alternative times in time axis. The wave fronts of vibration waves propagating from opposite side surfaces 14 in the direction (the second direction Z2) of the width w of the battery cell C may proceed to the electrolyte E filled inside the battery cell C, and vibration or flow that may suppress the formation or growth of dendrite or lithium salt precipitates generated inside the battery cell C may be formed from the vibration waves propagating in opposite directions, that is, in the direction of the width w of the battery cell C and in a direction opposite to the direction of the width w.

According to some embodiments of the present disclosure, an electrical pulse signal input to the vibrator V or physical vibration behavior output from the vibrator V by using an electrical pulse signal as an input may have the form of pulses separated from each other on the time axis, and the pulse signal as an input to the vibrator V and the vibration behavior output from the vibrator V may form an input-output causal relationship with respect to the vibrator V. For example, in the present specification, the fact that an electrical driving signal having a continuous or discontinuous waveform along the time axis is input to the vibrator V means that vibration behavior in a continuous or discontinuous pulse waveform is output from the vibrator V.

According to some embodiments of the present disclosure, the driving signal input to the vibrator V may have a continuous waveform (e.g., a continuous waveform such as a sine wave) or a discontinuous pulse waveform (e.g., a discontinuous pulse waveform having a square-wave pulse shape that periodically appears along the time axis). For example, according to some embodiments of the present disclosure, the driving signal having a continuous waveform may have a waveform that vibrates at the natural frequency (resonance frequency) of lithium crystals that form dendrites or lithium salts formed in the electrolyte E filled inside the battery cell C. Resonance may be generated to maximize or increase an amplification ratio of an amplitude w or intensity of vibration behavior output from the vibrator V as an output signal of the vibrator V to an amplitude w or intensity of a driving signal (having a continuous waveform) input to the vibrator V as an input signal of the vibrator V, the formation or growth of dendrite or lithium salt precipitates formed in the electrolyte E filled inside the battery cell C may be effectively suppressed, and vibration waves (e.g., ultrasonic vibration) having sufficient intensity to effectively decompose already formed dendrites or lithium salts may be generated.

According to some embodiments of the present disclosure, in order to calculate the frequency of the continuous waveform driving signal as the driving signal input to the vibrator V, lithium crystals that form dendrites or lithium salts formed in the electrolyte E filled inside the battery cell C may be modeled by a dumped model having one mass (m) and an elastic body (elastic modulus k) and may have a natural frequency or resonance frequency calculated as follows.

$${f}_{0} = \frac{1}{2 π} \cdot \sqrt{\frac{k}{m}} ( Hz )$$

Assuming that the lithium crystal is a spherical body, the natural frequency or resonance frequency may be calculated as follows.

$$f = \frac{1}{2 π} \sqrt{\frac{k}{ρ ( \frac{4}{3} π {r}^{3} )}}$$

k is the elastic modulus of lithium and may be set to 11 GPa,
ρ is the density of lithium and may be set to 534 kg/m3, and
r is the radius of the dendrite or lithium crystal and may be set to 40 μm.

For example, according to some embodiments of the present disclosure, the continuous waveform driving signal may be provided by an oscillator and a frequency multiplier or phase-locked loop (PLL) for shaping the frequency of the oscillator to the calculated natural frequency or resonance frequency of the lithium crystal.

According to some embodiments of the present disclosure, the driving signal input to the vibrator V may have a waveform in the form of a discontinuous pulse, and may be generated in the form of a pulse signal including pulses that are separated from each other along the time axis and periodically appear at regular intervals.

According to some embodiments of the present disclosure, the driving signal input to the vibrator V may have a discontinuous pulse waveform rather than a continuous waveform, for example, may be generated as a pulse signal including pulses that periodically appear. For example, a driving signal having a continuous waveform may increase physical fatigue on the internal configuration of the battery cell C while inducing continuous excitation to the internal configuration of the battery cell C, and may provide an environment vulnerable to long-term reliability or fatigue destruction of the internal structure of the battery cell C. In a state where the frequency of the drive signal having a continuous waveform is set to the natural frequency or resonance frequency of a lithium crystal, the degree of freedom in shaping the waveform including designing parameter of the waveform, such as the amplitude (w) and wavelength of the waveform may be relatively lower in a discontinuous pulse waveform as described below. Considering this, according to some embodiments of the present disclosure, the driving signal input to the vibrator V may be generated in the form of a discontinuous pulse waveform.

For example, the driving signal having the discontinuous pulse waveform may provide a constant rest period along the time axis with respect to the vibration wave or vibration behavior induced from the vibrator V toward the inside of the battery cell C. Fatigue on the internal configuration of the battery cell C may be alleviated, and a rest period may be provided between pulses that intermittently appear along the time axis of the driving signal having the pulse waveform. Unlike in the driving signal having a continuous waveform, fatigue due to continuous excitation of the internal structure of the battery cell C may be avoided through the rest period, and fatigue destruction of the internal structure of the battery cell C may be prevented. By controlling the on/off duty ratio of a pulse signal, it is possible to stretch the width (duration) of an intermittent pulse waveform and the rest period between pulse waveforms, and thus, the degree of freedom in shaping the waveform of the pulse signal may be increased. For example, the period (corresponding to the width of the pulse) in which vibration or excitation of the internal configuration of the battery cell C occurs and the rest period in which the vibration or excitation of the internal configuration of the battery cell C stops may be directly controlled.

According to some embodiments of the present disclosure, the driving signal input to the vibrator V may be formed as a discontinuous pulse waveform signal rather than a continuous waveform signal. For example, according to some embodiments of the present disclosure, the driving signal having the discontinuous pulse waveform may be shaped in a form in which pulses periodically appear while alternating between an on period and an off period, and a driving signal in the form of a pulse may be output from the switch on/off.

According to some embodiments of the present disclosure, the internal structure of the battery cell C may include first and second electrode plates 10a and 10b that are opposed to each other, an electrode assembly 10 including a separator 10c between the first electrode plate 10a and the second electrode plate 10b, an electrolyte E filled inside the case 18 of the battery cell C, and first and second lead members 51 and 52 electrically connected to the first and second electrode plates 10a and 10b of the electrode assembly 10, respectively, and forming charge and discharge paths between first and second electrode terminals 21 and 22 formed on the case 18 (an electrode surface 11) of the battery cell C. For example, the vibration wave or vibration behavior, which is transmitted toward the electrolyte E to suppress the formation or growth of dendrite or lithium salt precipitates depending on the vibration wave or vibration behavior induced from the vibrator V into the inside of the battery cell C, may have the possibility to increase mechanical fatigue of the internal configuration of the battery cell C while inducing periodic vibration in the electrode assembly 10 accommodated inside the case 18 of the battery cell C together with the electrolyte E and in the first and second lead members 51 and 52 connected to the electrode assembly 10. Considering this possibility, as described above, the driving signal input to the vibrator V may be formed to have a discontinuous pulse waveform rather than a continuous waveform. However, according to some embodiments, the driving signal input to the vibrator V may be formed to have a continuous waveform. For example, as described above, resonance may be induced in lithium crystals, which constitute dendrites or lithium salts, from a continuous waveform driving signal having the natural frequency or resonance frequency of the lithium crystals constituting the dendrites or lithium salts formed or growing in the electrolyte E, and by selectively inducing resonance for the lithium crystal in the internal configuration of the battery cell C, the vibration intensity may be increased with a high amplification rate selectively only for the lithium crystal.

The vibration intensity for the internal configuration of other battery cells C may be relatively reduced, while the vibration intensity for a desired lithium crystal may be selectively increased, and thus, unintended deterioration of mechanical properties of the internal configuration of other battery cells C may be prevented or reduced. For example, according to some embodiments of the present disclosure, the internal configuration of the battery cell C may be designed to have a natural frequency or resonance frequency that is outside the natural frequency or resonance frequency of the lithium crystals forming dendrites or lithium salts. For example, the mass and elastomeric properties of the internal configuration may be designed such that the natural frequency or resonance frequency of the internal configuration of the battery cell C deviates as far as possible from the natural frequency or resonance frequency of the lithium crystal.

For example, according to some embodiments of the present disclosure, in the driving signal having a discontinuous waveform, the widths and amplitudes or intensities of pulses spaced apart from each other with a rest period therebetween along the time axis may be generated sufficient to suppress the growth of dendrite or lithium salt precipitates formed on the electrolyte E or to decompose already formed dendrite or lithium salt precipitates, and may also be generated sufficient to avoid deterioration of mechanical properties of the internal configuration of the battery cell C, for example, deterioration of mechanical properties, such as fatigue strength, associated with fatigue failure. For example, according to some embodiments of the present disclosure, as the driving signal input to the vibrator V, the amplitude or intensity of the pulse waveform may be set within a range that does not exceed a level necessary to suppress or decompose the growth of dendrites or lithium salts.

According to some embodiments of the present disclosure, the driving signal input to the vibrator V may generate a vibration wave of ultrasonic vibration having a wavelength (about 1 MHz to about 30 MHZ) corresponding to an ultrasonic range, and may be generated to have a frequency or wavelength capable of generating ultrasonic vibration.

For example, according to some embodiments of the present disclosure, the electrolyte E may be in a liquid state and may function as a vibration transmission medium through which vibration waves generated from the vibrator V are propagated. For example, according to some embodiments of the present disclosure, the electrolyte E may be in a liquid state and thus may transmit vibration waves to the inside of the electrode assembly 10, and may block precipitation of dendrites and the like due to vibration gaps while transmitting the vibration waves to the inside of the assembly 10 capable of dendrite or lithium salt precipitation.

According to some embodiments of the present disclosure, the vibrator V may operate in a driving mode based on a continuous waveform and a driving mode based on a discontinuous waveform. As needed, one of the driving mode based on a continuous waveform and the driving mode based on a discontinuous waveform may be selected depending on monitored data, such as the formation size or growth rate of dendrite or lithium salt precipitates, depending on the formation size or growth rate of dendrite or lithium salt precipitates predicted according to the output characteristics of the battery cell C, or depending on statistical data according to the operating environment of the battery cell C. For example, by receiving a driving signal having a continuous waveform, resonance may be caused, by the vibrator V, in lithium crystals that constitute dendrites or lithium salts, and previously formed dendrite or lithium salt precipitates may be decomposed. In consideration of the durability of the battery cell C, vibration in the form of an intermittent pulse including a rest period may be generated rather than a continuous vibration wave. For example, in the driving mode based on a continuous waveform and the driving mode based on a discontinuous pulse waveform, a driving circuit for generating the continuous waveform and a driving circuit for generating the discontinuous pulse waveform may be alternatively connected to the vibrator V depending on the switching operation of a switch element, the driving circuits being connected to the vibrator V via the switch element.

For example, according to some embodiments of the present disclosure, the vibrator V may convert electrical vibration (waveform of a driving signal input to the vibrator V) into mechanical vibration (generation of a vibration wave or vibration behavior). In a specific embodiment, the vibrator V may be formed as a piezoelectric vibrator for converting electrical vibration into mechanical vibration by using a piezoelectric effect.

According to some embodiments of the present disclosure, the battery pack including the plurality of battery cells C may include a battery management system (BMS) for controlling charging and discharging operations of the battery cells C, and control of the vibrator V may be implemented by the BMS. For example, according to some embodiments of the present disclosure, the vibrator V may be operated based on monitoring results collected by the BMS from the plurality of battery cells C or at least one of the plurality of battery cells C. As previously described, as parameters through which the electrolyte E filled inside the battery cell C or the precipitation of dendrites or lithium salts formed in the electrolyte E may be measured or predicted, the measured values of parameters related to electrical resistance characteristics or mechanical vibration or flow characteristics may be obtained as monitored results, and the BMS may determine whether to drive the vibrator V according to the monitored results and may select any one of the different driving modes of the vibrator V, for example, the driving mode based on a continuous waveform and the driving mode based on a discontinuous pulse waveform.

According to some embodiments of the present disclosure, if the degree of precipitation of dendrites or lithium salts is measured or predicted to be at a relatively high level, in a driving mode in which the driving signal of the vibrator V is applied as a continuous waveform and a driving mode in which the driving signal of the vibrator V is applied as a discontinuous pulse waveform, depending on the degree of precipitation of dendrites or lithium salts from the electrolyte E measured or predicted from the state information of the battery cell C, the BMS may control the vibrator V in a driving mode in which a continuous waveform having the natural frequency or resonance frequency of the lithium crystals forming the dendrites or lithium salts is applied. In contrast, if the degree of precipitation of dendrites or lithium salts is measured or predicted to be at a relatively low level, the BMS may control the vibrator V in a driving mode based on a discontinuous pulse waveform including pulses waveforms spaced apart from each other with a rest period therebetween along the time axis.

According to some embodiments of the present disclosure, the BMS may estimate the degree of dendrite or lithium salt precipitation inside the battery cell C by combining state information, such as open circuit voltage (OCV), state of charge (SOC), and heat generation state, which indicates the degree of deterioration in the electrical charging and discharging characteristics of the battery cell C. For example, the BMS, which monitors the status of the battery cell C by obtaining the status information to control the charging and discharging operation of the battery cell C, may control the driving of the vibrator V to suppress the formation or growth of dendrites or lithium salts formed inside the battery cell C or to decompose the dendrites or lithium salts. For example, according to some embodiments of the present disclosure, the BMS may control the charging and discharging operations of the battery cell C based on the state information of the battery cell C and may also control the driving of the vibrator V, located on one side of the battery cell C, based on the status information of the battery cell C.

According to some embodiments of the present disclosure, by controlling the driving of the vibrator V based on state information obtained from the battery cell C, for example, collected from a plurality of battery cells C, in order to control the charging and discharging operation of the battery cell C, the vibrator V may be controlled, by a circuit configuration for controlling the charging and discharging operations of the battery cell C, without a basis for controlling the vibrator V or a separate circuit configuration for collecting data or monitoring the battery cell C. For example, referring to the drawings, according to some embodiments of the present disclosure, the BMS may capture abnormal situations, such as overcharging, overdischarging, and overheating, based on state information collected from the battery cell C and thus may generate a switching signal for switching on/off operations of a discharge switch SW1 and a charge switch SW2 connected on the charge and discharge path of the battery cell C.

For example, according to some embodiments of the present disclosure, the vibrator V may generate a vibration waveform for the battery cell C by receiving a driving power as an input, may suppress the formation or growth of dendrite or lithium salt precipitates formed inside the electrolyte E that participates in the charge and discharge reaction of the battery cell C, and may also generate a mechanical vibration waveform for the electrolyte E to decompose or remove previously formed dendrite or lithium salt precipitates.

According to some embodiments of the present disclosure, the vibration of the vibrator V may be propagated to the electrolyte E contained within the case 18 through the case 18 surrounding the battery cell C, and may be propagated in the form of a longitudinal wave in which the direction of travel of the vibration wave and the direction of vibration of the vibration wave are substantially the same by using the electrolyte E contained within the case 18 as a medium through which the vibration wave propagates. For example, the vibration of the vibrator V may create a difference in concentration of the electrolyte E functioning as a medium through which the vibration wave propagates. For example, the vibration wave of the vibrator V may form a pressure difference or a flow speed difference inside the electrolyte E by alternately forming relatively dense parts and relatively sparse parts and may be propagated through the electrolyte E. The vibration of the vibrator V may create a pressure difference or a flow speed difference across the electrolyte E in the direction of travel of the vibration wave or the direction of vibration of the vibration wave from a static state favorable for the precipitation of dendrites or lithium salts, for example, a static state in which the pressure difference or flow speed of the electrolyte E is substantially zero or close to zero, and may suppress the generation or growth of dendrite or lithium salt precipitates, or decompose dendrites or lithium salts. For example, according to some embodiments of the present disclosure, the fact that the vibration wave generated from the vibrator V creates a flow speed difference or pressure difference with respect to the electrolyte E inside the case 18 may means that, if assuming that the electrolyte E inside the case 18 through which the vibration wave propagates is in a quasi-static state, the pressure difference and the flow speed difference may be interchangeable based on Bernoulli's theorem. Considering this, according to some embodiments of the present disclosure, it may be understood that the vibration wave generated from the vibrator V may create a pressure difference with respect to the electrolyte E contained in the case 18 or create a difference in flow speed for the electrolyte E contained in the case 18.

According to some embodiments of the present disclosure, if it is determined that the degree of formation or growth of dendrites or lithium salts is relatively severe according to the state information of the battery cell C collected by the BMS as a driving circuit for applying a driving signal to the vibrator V, for example, according to the degree of formation or growth of dendrites or lithium salts generated inside the battery cell C, the BMS may drive the vibrator V by using a continuous waveform having a frequency corresponding to the natural frequency or resonance frequency of crystals of dendrites or lithium salts. In contrast, if it is determined that the degree of formation or growth of dendrites or lithium salts is relatively minor, the BMS may drive the vibrator V by using a discontinuous pulse waveform including a plurality of pulse waveforms spaced apart from each other along the time axis with a rest period therebetween. However, in various embodiments, it may be understood that a discontinuous pulse waveform (e.g., a rectangular pulse waveform) including a plurality of pulses spaced apart from each other along the time axis is a combination of continuous waveforms having various different frequencies through Fourier transform. By driving the vibrator V by using a discontinuous waveform including a continuous waveform having the resonance frequency, the amplification rate of the input and output signal may be relatively increased, and thus, a vibration wave, which is output at a high amplification rate occurring resonance state or near-resonance state to crystal of dendrite or lithium salts, may be generated from a discontinuous pulse waveform.

The reference number 200 shown in FIG. 1 may refer to a wiring circuit 200 including a bus bar B for electrically connecting different battery cells C, and the wiring circuit 200 may be arranged to overlap the flexible printed circuit board 100 or a driving circuit for applying a driving signal to the vibrator V. For example, according to some embodiments of the present disclosure, the wiring circuit 200 including the bus bar B and the flexible printed circuit board 100 as a driving circuit for the vibrator V may be in the form of a series of flexible circuit boards stacked in an overlapping manner with respect to each other.

According to the present disclosure, the formation or growth of dendrites or lithium salts, which may precipitate on the electrolyte charged inside the battery cell as the battery cell is repeatedly charged and discharged, may be suppressed, and previously formed dendrites or lithium salts may decompose. Therefore, a battery pack, which may prevent shortening the lifespan of a battery cell by promoting electrochemical reactions for charging and discharging the battery cell and may prevent accidents such as fire or explosion due to internal short circuit, may be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims, and their equivalents.

What is claimed is:

1. A battery pack comprising:
a battery cell including a case forming an external shape, an electrode assembly, and an electrolyte, the electrode assembly and the electrolyte being accommodated together inside the case; and
a vibrator on the case of the battery cell and configured to generate a vibration wave propagating inside the case to suppress or decompose precipitation of dendrites or lithium salts from the electrolyte.

2. The battery pack as claimed in claim 1, wherein the vibrator is further configured to generate a vibration wave that propagates from outside of the case through the case to the electrolyte inside the case.

3. The battery pack as claimed in claim 1, wherein the case includes:
a pair of main surfaces facing each other in a first direction, the pair of main surfaces occupying a largest area of the case;
a pair of side surfaces facing each other in a second direction crossing the first direction; and
an electrode surface, on which an electrode terminal is formed, and a bottom surface opposite to the electrode surface, the electrode surface and the bottom surface facing each other in a third direction crossing the first and second directions.

4. The battery pack as claimed in claim 3, wherein the battery cell includes a plurality of battery cells arranged in the first direction so that the main surfaces face each other.

5. The battery pack as claimed in claim 3, wherein the vibrator is on a side surface of the battery cell.

6. The battery pack as claimed in claim 3, wherein a side surface of the battery cell, on which the vibrator is located, has a narrower area than a main surface of the battery cell, an electrode surface of the battery cell, and a bottom surface of the battery cell.

7. The battery pack as claimed in claim 3, wherein the battery cell is configured to:
have a thickness of the battery cell in the first direction in which the pair of main surfaces face each other,
have a width of the battery cell in the second direction in which the pair of side surfaces face each other, and
have a height of the battery cell in the third direction in which the electrode surface and the bottom surface face each other,
wherein the width of the battery cell is greater than the height of the battery cell, and the height of the battery cell is greater than the thickness of the battery cell.

8. The battery pack as claimed in claim 3, wherein the vibrator is further configured to generate a vibration wave propagating along a width of the battery cell, which is longest among a thickness of the battery cell, a width of the battery cell, and a height of the battery cell, from a side surface of the battery cell, which has a smallest area from among a main surface, side surface, electrode surface, and bottom surface of the battery cell.

9. The battery pack as claimed in claim 3, wherein the vibrator includes a pair of vibrators facing each other on the pair of side surfaces facing each other in the second direction.

10. The battery pack as claimed in claim 1, further comprising a driving circuit electrically connected to the vibrator,
wherein the driving circuit is configured to generate an electrical driving signal to output a vibration wave propagating inside the battery cell.

11. The battery pack as claimed in claim 10, further comprising a battery management system (BMS) configured to control an operation of the driving circuit to control charging and discharging operations of the battery cell.

12. The battery pack as claimed in claim 11, wherein the BMS is configured to, based on state information obtained from the battery cell, select between a driving mode, in which a driving signal of the vibrator is applied as a continuous waveform, and a driving mode, in which the driving signal of the vibrator is applied as a discontinuous pulse waveform, and control driving of the vibrator in a selected driving mode.

13. The battery pack as claimed in claim 12, wherein the BMS is further configured to, according to sizes or growth rates of dendrite or lithium salt precipitates measured or predicted from state information of the battery cell, select between a driving mode based on a continuous waveform having a natural frequency or resonant frequency of lithium crystals forming the dendrites or lithium salts and a driving mode based on a discontinuous waveform including pulse waveforms spaced apart from each other with a rest period between the pulse waveforms along a time axis and control driving of the vibrator in a selected driving mode.

14. The battery pack as claimed in claim 11, wherein the BMS is configured to control charging and discharging operations of the battery cell based on state information obtained from the battery cell and control driving of the vibrator.

15. The battery pack as claimed in claim 1, wherein the case includes:
a pair of main surfaces facing each other in a first direction, the pair of main surfaces occupying a largest area of the case; and
a pair of side surfaces facing each other in a second direction crossing the first direction,
wherein the vibrator includes a pair of vibrators face each other on the pair of side surfaces facing each other in the second direction,
wherein driving signals of alternating pulse waveforms are applied to the pair of vibrators on the pair of side surfaces facing each other.

16. The battery pack as claimed in claim 1, wherein a driving signal applied to the vibrator has a continuous waveform.

17. The battery pack as claimed in claim 16, wherein the driving signal has a continuous waveform having a natural frequency or resonance frequency of lithium crystals forming dendrites or lithium salts.

18. The battery pack as claimed in claim 1, wherein a driving signal applied to the vibrator has a discontinuous pulse waveform.

19. The battery pack as claimed in claim 18, wherein the driving signal has a pulse waveform including a plurality of pulses spaced apart from each other with a rest period between the plurality of pulses along a time axis.

20. The battery pack as claimed in claim 1, wherein the vibrator generates ultrasonic vibration in an ultrasonic wavelength range.

21. The battery pack as claimed in claim 1, wherein the vibrator includes a piezoelectric vibrator configured to convert electrical vibration into mechanical vibration through an piezoelectric effect.
